(19) United States
(12) Patent Application Publication
(10) Pub. No.: US 2004/0080666 A1
(43) Pub. Date: Apr. 29, 2004

(54) Portable electronic device

(75) Inventors: Kiyoshi Kawano, Saitama (JP); Gouji Funatsu, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/687,598

(22) Filed: Oct. 20, 2003

(30) Foreign Application Priority Data
Oct. 21, 2002 (JP) P2002-305631

(51) Int. Cl. H04N 15/00; H04N 5/225

(52) U.S. Cl. 348/373; 348/42

(57) ABSTRACT

A portable electronic device provided with a function which is required to be preset before supplying electric power to the device is provided. The device comprises a switch, an operating member, and a battery chamber. The switch is used to preset the function. The operating member is used to switch the switch. The battery chamber is for loading at least one battery. Further, the operating member is arranged inside the battery chamber and the operating member is concealed with the battery when the battery is loaded inside the battery chamber.

### BACKGROUND OF THE INVENTION

1. Field of the Invention

The present invention relates to an electronic device provided with functions that should be switched or preset when or before starting the system. Particularly, the invention relates to a portable electronic device that comprises video signal output systems based on different standards.

2. Description of the Related Art

When it is required to switch a function of an electronic device, for example, a function which is directly related with a clock frequency, or a function for which a program should be read and stored in the system memory when booting the system, the selection of the desired function should be preset when or before supplying the power or booting the system. More specific examples are the set up of a SCSI (small computer system interface) ID number or alteration of a video signal transmission standard, by using a DIP switch or a rotary switch. As a standard for video signals or TV systems, one of the NTSC standard, PAL standard, and SECAM standard is generally adopted in each area of the world. Therefore, a function for switching a video signal standard or TV standard should be provided for a portable electronic device that comprises a video output function, such as a video camera, digital still camera, and binoculars provided with a digital still camera, for enabling the electronic device to be used in areas which adopt the different standards. Conventionally, selection of the video signal standard or TV standard, for example, is carried out on a menu that is displayed on the monitor of a device, so that the selection is electronically achieved by means of software.

### SUMMARY OF THE INVENTION

Therefore, an object of the present invention is to facilitate operations for selecting functions that should be switched or preset when or before supplying the electric power to the device and to prevent incorrect operation.

According to the present invention, a portable electronic device provided with a function which is required to be preset before supplying electric power to the device is provided that comprises a switch, an operating member, and a battery chamber.

The switch is used to preset the function. The operating member is used to switch the switch. The battery chamber is for loading at least one battery. Further, the operating member is arranged inside the battery chamber and the operating member is concealed with the battery when the battery is loaded inside the battery chamber.

### BRIEF DESCRIPTION OF THE DRAWINGS

The objects and advantages of the present invention will be better understood from the following description, with reference to the accompanying drawings in which:

FIG. 1 is a plan view showing an inner arrangement and structure of a digital-camera-provided binoculars of an embodiment to which the present invention is applied;

FIG. 2 is a cross-sectional view taken along the line II-II of FIG. 1, which shows a retracted position;

FIG. 3 is a cross-sectional view, similar to FIG. 2, which shows an extended position;

FIG. 4 is a plan view of a support-plate assembly provided inside a casing;

FIG. 5 is a plan view of the right and left mount plates arranged above the support-plate member;

FIG. 6 is an elevational view observed along line VI-VI of FIG. 5;

FIG. 7 is a cross-sectional elevational view along line VII-VII of FIG. 1;

FIG. 8 is a cross-sectional elevational view of an alternate embodiment corresponding to FIG. 7;

FIG. 9 is a perspective view of the digital-camera-provided binoculars with the battery cover opened; and

FIG. 10 is a perspective view of the digital-camera-provided binoculars with the battery cover opened, in which a part of the battery cover and the casing are cutaway.

### DESCRIPTION OF THE PREFERRED EMBODIMENTS

The present invention is described below with reference to the embodiment shown in the drawings.

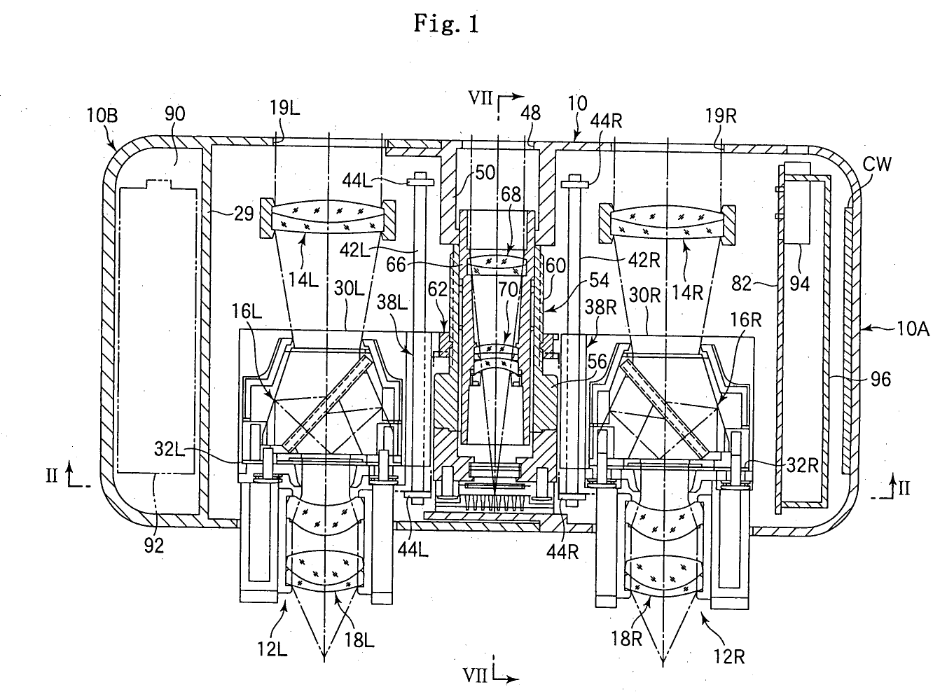

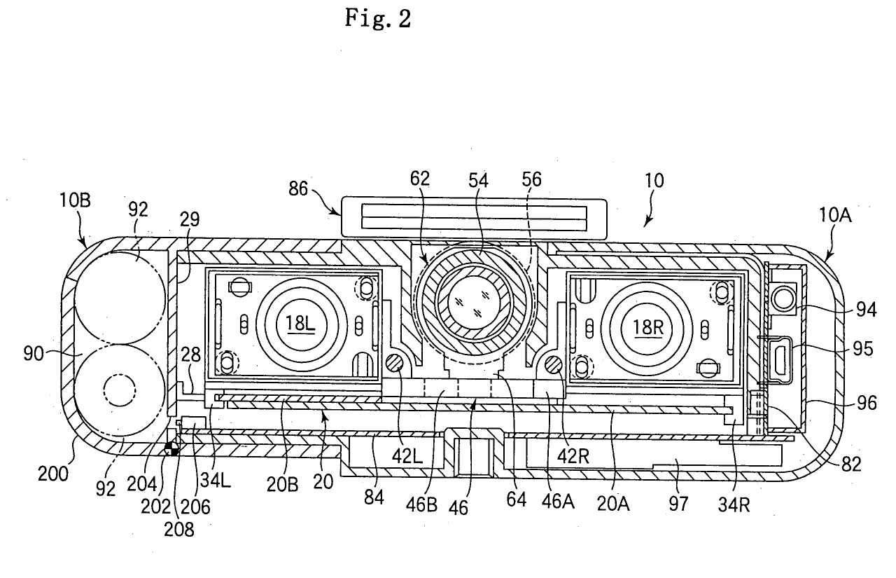

FIG. 1 is a plan view showing an inner arrangement and structure of the digital-camera-provided binoculars, which is an embodiment to which the present invention is applied. FIG. 2 is a cross-sectional view taken along the line II-II of FIG. 1. In the present embodiment, the digital-camera-provided binoculars are covered with a rectangular parallelepiped casing 10 which is comprised of a main casing section 10A and a movable casing section 10B.

Inside the casing 10, a pair of telescopic lens systems 12R and 12L is provided. The telescopic lens systems 12R and 12L are symmetrically arranged and are used for binocular observation with right and left eyes. The right telescopic lens system 12R is assembled in the main casing section 10A, and is comprised of an objective lens system 14R, an erecting prism system 16R, and an ocular lens system 18R. On the front of the main casing section 10A, an objective window 19R which is aligned with the right objective lens system 14R is formed. On the other hand, the left telescopic lens system 12L is assembled in the movable casing section 10B, and is comprised of an objective lens system 14L, an erecting prism system 16L, and an ocular lens system 18L. On the front of the movable casing section 10B, an objective window 19L which is aligned with the left objective lens system 14L is formed.

Note that, in the following description, for convenience of explanation, the front side and the rear side of the binoculars are respectively defined as the objective side and ocular side of the telescopic lens systems 12R and 12L of the binoculars.

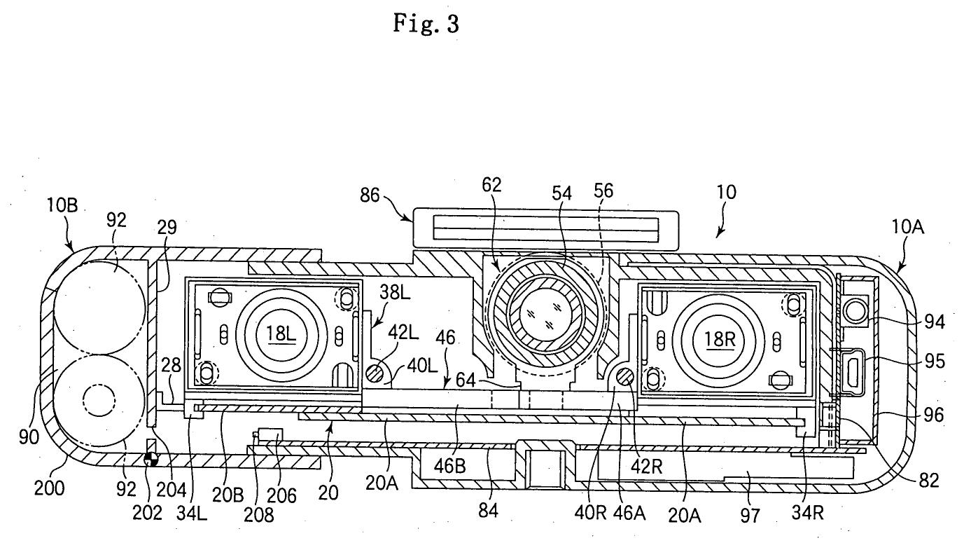

The movable casing section 10B is slidably engaged with the main casing section 10A so that the movable casing section 10B can be drawn out from the main casing section 10A in the lateral direction. Namely, the movable casing section 10B can be arbitrarily moved or slid in the lateral direction in relation to the main casing section 10A between a retracted position as shown in FIG. 2 and a maximum-extended position as shown in FIG. 3. A suitable friction is designed to act on the slidably engaged surfaces of the movable casing section 10B and the main casing section 10A. Thereby, a certain extension or extraction force must be exerted on the movable casing section 10B and the main casing section 10A to slide the movable casing section 10B relative to the main casing section 10A. Therefore, the movable casing section 10B can be suspended at an arbitrary position between the retracted position (FIG. 2) and the maximum-extended position (FIG. 3) by means of the friction between the slidably engaged surfaces.

As it is obvious from FIG. 2 and FIG. 3, when the 0.5 movable casing section 10B is drawn out or extended from the main casing section 10A, the left telescopic lens system 12L is conveyed with the movable casing section 10B, while the right telescopic lens system 12R remains still with the main casing section 10A. Namely, an interpupillary adjustment can be carried out by extending the movable casing section 10B from the main casing section 10A and adjusting a distance between the optical axes of the ocular lens systems 18R and 18L of the right and left telescopic lens systems 12R and 12L.

In the present embodiment, the objective lens system 14R of the right telescopic lens system 12R is fixedly mounted on the main casing section 10A, while the erecting prism system 16R and the ocular lens system 18R are movable back and forth with respect to the objective lens system 14R, whereby the focus of the right telescopic lens system 12R is adjusted. Similarly, the objective lens system 14L of the left telescopic lens system 12L is fixedly mounted on the movable casing section 10B, while the erecting prism system 16L and the ocular lens system 18L are movable back and forth with respect to the objective lens system 14L, whereby the focus of the left telescopic lens system 12L is adjusted.

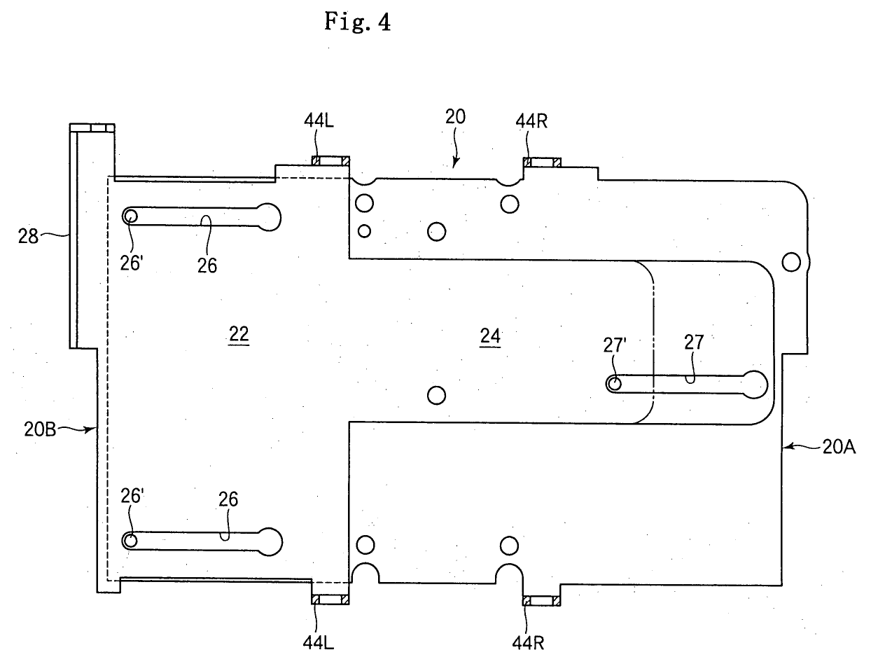

To carry out the above-described interpupillary adjustment and the focusing, a support-plate assembly 20, as shown in FIG. 4, is provided on the bottom side of the casing 10. Note that, the support-plate assembly 20 is omitted in FIG. 1, so that undue complexity of the drawing is prevented.

The support-plate assembly 20 comprises a rectangular fixed-plate member 20A, which is suitably secured to the main casing section 10A, and a slide-plate member 20B, which is slidably laid on the fixed-plate member 20A and suitably secured to the movable casing section 10B. The slide-plate member 20B has a rectangular section 22 with a width substantially equal to the length of the rectangular fixed-plate member 20A, and an extended section 24 which integrally extends out from the rectangular section 22 in the right direction. The objective lens system 14R of the right telescopic lens system 12R is fixedly disposed at a predetermined position on the rectangular fixed-plate member 20A and the objective lens system 14L of the left telescopic lens system 12L is fixedly disposed at a predetermined position on the slide-plate member 20B.

On the rectangular section 22 of the slide-plate member 20B, there is formed a pair of guide slots 26. Further a guide slot 27 is formed on the extended section 24 of the slide-plate member 20B. On the other hand, a pair of guide bolts 26′, which slide along the guide slots 26, and guide bolt 27′, which slides along the guide slot 27, are securely attached to the fixed-plate member 20A. The guide slots 26 and 27 have the same length in the lateral direction of the binoculars. The length corresponds to the movable distance of the extendible casing 10, which is described by the transformation of casing 10 from the retracted position of FIG. 2 to the maximum-extended position of FIG. 3.

As apparent from FIG. 2 and FIG. 3, the support-plate assembly 20 is arranged in the casing 10 at a suitable distance from the bottom of the casing 10. The rectangular fixed-plate member 20A is suitably secured to the main casing section 10A, and the slide-plate member 20B is suitably secured to the movable casing section 10B. Note that, in the present embodiment, a support section 28 is provided along the left side end of the rectangular section 22 in order to secure the slide-plate member 20B to the movable casing section 10B. Namely, the support section 28 is suitably affixed to the partition 29 provided in the movable casing section 10B.

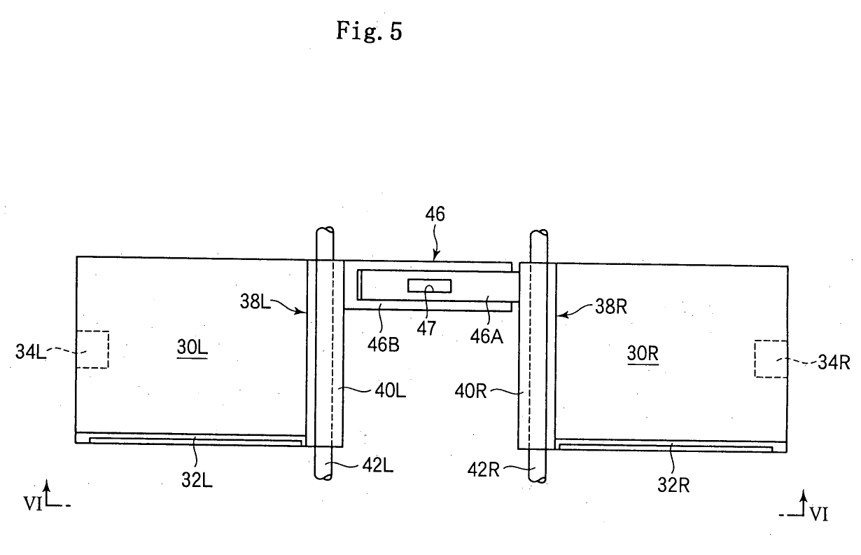

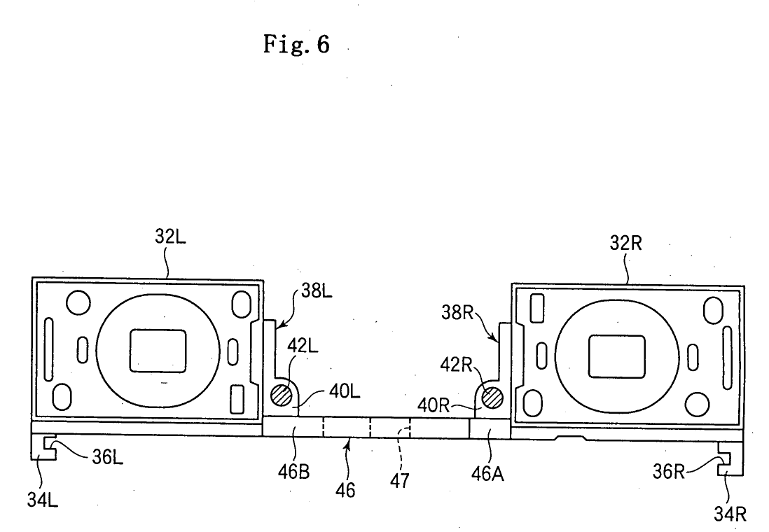

In FIG. 5, a right mount-plate 30R on which the erecting prism system 16R of the right telescopic lens system 12R is mounted and a left mount-plate 30L on which the erecting prism system 16L of the left telescopic lens system is mounted are depicted. As is apparent from FIG. 5 and FIG. 6, upright plates 32R and 32L are provided for each of the right mount-plate 30R and the left mount-plate 30L along the respective rear side edges. As shown in FIG. 1, the right upright plate 32R is used as a frame for attaching the right ocular lens system 18R and the left upright plate 32L is used as a frame for attaching the left ocular lens system 18L.

As shown in FIG. 6, a guide shoe 34R is attached on the underside of the right mount plate 30R along the right side edge of the plate 30R. A groove 36R that slidably receives a right side edge of the rectangular fixed-plated member 20A is formed on the guide shoe 34R, as shown in FIG. 2 and FIG. 3. Further, along the left side edge of the right mount plate 30R, a sidewall 38R is provided. The lower side of the sidewall 38R is formed as a swollen portion 40R where a through bore for slidably receiving a guide rod 42R is formed. Both ends of the guide rod 42R are fitted into holes formed on a pair of support pieces 44R that are integrally provided on each of the front and rear side edges of the rectangular fixed-plate member 20A, so that the guide rod 42R is suitably secured to the fixed-plate member 20A.

On the other hand, a guide shoe 34L is attached on the underside of the left mount plate 30L along the left side edge of the plate 30L. A groove 36L that slidably receives a left side edge of the slide-plated member 20B is formed on the guide shoe 34L, as shown in FIG. 2 and FIG. 3. Further, along the right side edge of the left mount plate 30L, a sidewall 38L is provided. The lower side of the sidewall 38L is formed as a swollen portion 40L where a through bore for slidably receiving a guide rod 42L is formed. Both ends of the guide rod 42L are fitted into holes formed on a pair of support pieces 44L that are integrally provided on each of the front and rear side edges of the slide-plate member 20B, so that the guide rod 42L is suitably secured to the slide-plate member 20B.

Note that, the pair of support pieces 44R and the pair of support pieces 44L are depicted in FIG. 1 despite the other elements of the support-plate assembly 20 being neglected.

Accordingly, as described above, the left telescopic lens system 12L is moved together with the movable casing section 10B when the movable casing section 10B is drawn out leftward from the main casing section 10A, so that the distance between the optical axes of the ocular lens system 18R and 18L of the right and left telescopic lens systems 12R and 12L, i.e. interpupillary distance, can be adjusted.

Further, since the objective lens system 14R of the right telescopic lens system 12R is arranged in the front side of the right mount plate 30R, when the right mount plate 30R is translated back and forth along the guide rod 42R, the distance between the objective lens system 14R and the erecting prism system 16R can be adjusted, thereby the focusing operation for the right telescopic lens system 12R can be carried out. Similarly, since the objective lens system 14L of the left telescopic lens system 12L is arranged in the front side of the left mount plate 30L, when the left mount plate 30L is translated back and forth along the guide rod 42L, the distance between the objective lens system 14L and the erecting prism system 16L can be adjusted, thereby the focusing operation for the left telescopic lens system 12L can be carried out.

In order to translate the right and left mount plates 30R and 30L integrally along the respective guide rods 42R and 42L, while allowing lateral translation of the left mount plate 30L with respect to the right mount plate 30R, as most favorably described in FIG. 5, the mount plates 30R and 30L are interconnected to each other by an expandable coupler 46.

In detail, in the present embodiment, the coupler 46 is comprised of a bar member 46A that extends from the front end of the swollen portion 42R of the sidewall 40R and slide member 46B that slidably accepts the bar member 46A. Both the bar member 46A and the slide member 46B have a length that is sufficient for the bar member 46A and the slide member 46B to maintain slidable engagement even when the movable casing section 10B is extended from the retracted position (FIG. 2) to the maximum-extended position (FIG. 3). Thereby, the right mount plate 30R and left mount plate 30L can be integrally translated along the guide rods 42R and 42L, independent of the extended length of the movable casing section 10B from the main casing section 10A. Note that, the bar member 46A is provided with a rectangular bore 47, a function of the bore 47 will be explained later.

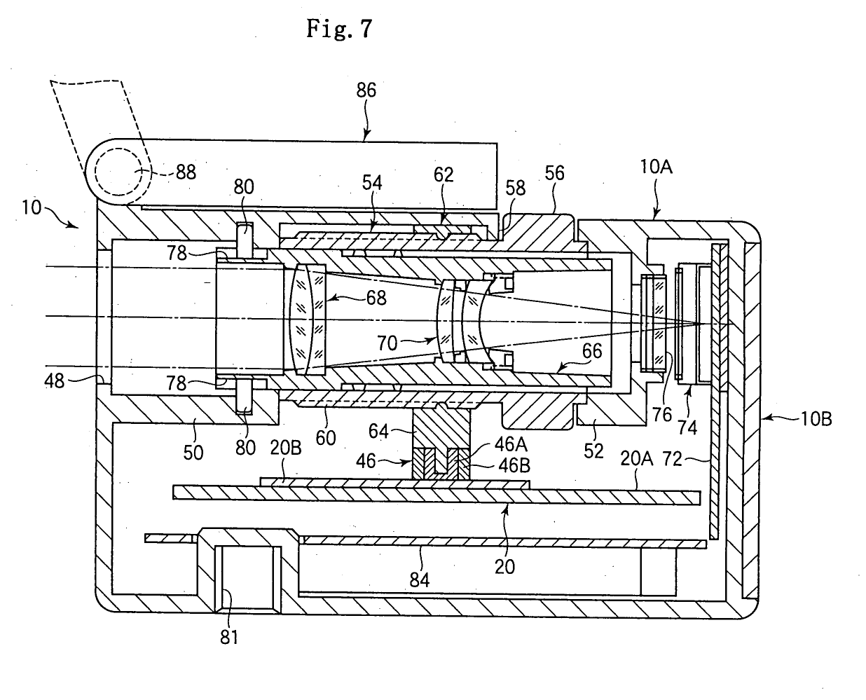

FIG. 7 is a cross sectional elevational view along line VII-VII of FIG. 1. As is apparent from FIG. 1 and FIG. 7, a circular opening 48 is formed in the front sidewall of the main casing section 10A. The circular opening 48 is positioned at the center of casing 10 when the movable casing section 10B is positioned at the retracted position with respect to the main casing section 10A.

A fore sleeve member 50 protrudes inwardly and integrally from the inner face of the front sidewall of the main casing section 10A so as to surround the circular opening 48. Further, the top of the fore sleeve member 50 is integrated with the main casing section 10A, as shown in FIG. 7. On the other hand, a back sleeve member 52 is arranged on the rear side of the fore sleeve member 50, in a position separated from the fore sleeve member 50 at a predetermined distance. The back sleeve member 52 is integrally suspended from the inner face of the ceiling of the main casing section 10A.

The fore sleeve member 50 and the back sleeve member 52 are aligned and a focusing drive barrel 54 is rotatably supported between the fore and back sleeve members 50 and 52. The focusing drive barrel 54 is integrally provided with a focusing drive ring 56 which is arranged in the vicinity of the back sleeve member 54. A part of the focusing drive ring 56 is exposed outside the casing 10 through a rectangular opening 58 formed on the ceiling of the main casing section 10A. Note that, an exposed portion of the focusing drive ring 56 is rotated by a user when focusing the pair of telescopic lens systems 12R and 12L.

A male thread 60 is formed on the outer periphery of the focusing drive barrel 54, between the front end and the focusing drive ring 56. Further, the male thread 60 of the focusing drive barrel 54 mates with a female thread formed on the inner periphery of an annular frame 62. As apparent from FIG. 2, FIG. 3, and FIG. 7, a protrusion portion 64 that radially projects outward from the annular frame 62 is formed. The front end of the protrusion portion 64 is fitted into the rectangular bore 47 formed on the bar member 46A of the coupler 46. Therefore, when the focusing drive ring 56 is rotated, the annular frame 62 is translated along its axial direction since the annular frame 62 is mated with the male thread 60 of the focusing drive barrel 54. Further, the direction of translation depends on the rotational direction of the focusing drive ring 56. Namely, the focusing drive barrel 54 and the annular frame 62 provide a motion conversion mechanism that transforms the revolution of the focusing drive barrel 54 to linear translation of the annular frame 62.

The right and left mount plate members 30R and 30L are also translated together with the annular frame 62, for the reason that the front end of the protrusion portion 64 of the annular frame 62 is fitted into the rectangular bore 47 of the bar member 46A of the coupler 46. Namely, the distance between the objective lens systems (14R, 14L), and the respective erecting prism systems (16R, 16L) is adjusted by the rotation of the focusing drive ring 56, whereby the focusing operation for the telescopic lens systems (12R, 12L) is carried out.

In the present embodiment, the pair of the telescopic lens systems 12R and 12L, for example, is designed to bring about pan-focus when the distance between the objective lens systems (14R, 14L) and respective erecting prism systems (16R,16L) is minimum, in which an object within a range of 40 m to infinity is in focus. When observing an object within a range of 2 m to 40 m, the image of the object is brought into focus by separating the erecting prism systems (16R, 16L) from their respective objective lens systems (14R, 14L) by the revolution of the focusing drive barrel 54. Naturally, when the erecting prism systems (16R, 16L) are separated by the maximum distance from the respective objective lens systems (14R, 14L), an object at a distance of 2 m is brought into focus.

Inside the focusing drive barrel 54, a lens barrel 66 is provided. A photographing optical system which comprises a first lens group 68 and a second lens group 70 is held in the lens barrel 66. On the other hand, an electric circuit board 72 provided with a solid-sate image-pickup device, such as a CCD 74, is attached on the inner face of the rear sidewall of the main casing section 10A. The CCD 74 is arranged so that the imaging surface of the CCD 74 is aligned with the photographing optical system (68, 70). At the rear end of the back sleeve member 52, an inner annular flange is provided for holding an optical low-pass filter. Namely, in the present embodiment, the digital-camera-provided binoculars are provided with a photographing function of a digital camera, and an image of the object is formed on the imaging surface of the CCD 74 through the optical low-pass filter 76 due the photographing optical system (68, 70).

A focusing mechanism does not need to be incorporated into the lens barrel 66 when the photographing optical system (68, 70) is designed to provide pan-focus, in which objects in the foreground and the background (a range from a certain distance to the infinite distance) are simultaneously made in focus, and when only an object within the pan-focus range is photographed. However, a focusing mechanism is required when the binoculars provided with digital the camera of the present embodiment is designed to photograph a foreground object (e.g. an object at 2 m distance), similar to a normal digital still camera.

Therefore, in the present embodiment, the female thread is formed on the inner periphery of the focusing drive barrel 54 and the male thread is formed on the outer periphery of the lens barrel 66, so that the lens barrel 66 is screwed into the focusing drive barrel 54. Further, the front end of the lens barrel 66 is fitted into the fore sleeve member 50 and a pair of key grooves 78 of predetermined length is formed along the longitudinal axis of the lens barrel 66 from the front end, as shown in FIG. 7. On the other hand, nearby the rear end of the fore sleeve member 50, a pair of bores is formed, extending in opposite radial directions, into which the key elements 80, that mate with each of the key grooves 78, are planted. Namely, the rotation of the lens barrel 66 is prevented by the mating engagement between the key grooves 78 and the key elements 80.

Consequently, when the focusing drive barrel 54 is rotated by a rotational operation of the focusing drive ring 56, the lens barrel 66 is translated along its optical axis. Namely, the female thread formed on the inner periphery of the focusing drive barrel 54 and the male thread formed on the outer periphery of the lens barrel 66 provide a motion conversion mechanism that transforms the revolution (rotational movement) of the focusing drive barrel 54 to translation (linear movement) of the lens barrel 66. Thereby, the motion conversion mechanism functions as the focusing mechanism of the lens barrel 66.

The male thread 60 which is provided on the outer periphery of the focusing drive barrel 54 and the female thread provided on the inner periphery the focusing drive barrel 54 are formed in the opposite directions with respect to each other. Therefore, the lens barrel 66 is separated from the CCD 74 when the focusing drive barrel 54 is rotated in a direction which separate the erecting prism systems 16R and 16L from each of the objective lens systems 14R and 14L. As a result, an object in the foreground, which is outside of the pan-focus range, can be focused and its image can be clearly produced on the imaging surface of the CCD 74. Needless to say, the pitches of the male and female threads which are provided on the outer and inner periphery of the focusing drive barrel 54 are independent of each other, but are dependent on optical characteristics of the telescopic optical systems (12R, 12L) and the photographing optical system (67, 70).

As shown in FIGS. 2, 3, and 7, a female screw bore 81, into which a male screw of a camera platform of a tripod is screwed, is formed on the bottom surface of the main casing section 10A. As is apparent from FIG. 2, when the movable casing section 10B is at the retracted position with respect to the main casing section 10A, the female screw bore 81 is positioned at the center of the casing 10 in the lateral direction, right under the axis of the photographing optical system (68, 70). Further, as shown in FIG. 7, the female screw bore 81 is arranged nearby the forefront of the main casing section 10A.

As shown in FIGS. 1, 2, and 3, an electric power source circuit board 82 is provided inside the right end portion of the main casing section 10A and is suitably held by the main casing section 10A. Further, as shown in FIGS. 2 and 3, a main control circuit board 84 is provided between the base of the main casing section 10A and the support-plate assembly 20, so that the main control circuit board 84 is suitably supported by the base of the main casing section 10A. The main control circuit board 84 is provided with electronic devices, such as a microcomputer, memory, and the like. The CCD-mount electric circuit board 72 and the electric power source circuit board 82 are suitably connected to the main control circuit board 84 through flexible flat wire cables (not shown).

In the present embodiment, as shown in FIGS. 2, 3, and 7, an LCD monitor 86 is provided on the top of the main casing section 10A. The LCD monitor 86 is rotatably attached to a shaft 88 provided along the fore front edge of the ceiling as shown in FIG. 7. Normally, the LCD monitor 86 is positioned at a retracted position which is indicated by a solid line in FIG. 7. In this position, the screen of the LCD monitor 86 is laid down and faces the ceiling of the main casing section 10A, so that the screen of the LCD monitor 86 cannot be observed. When photographing operations are carried out by using the CCD 74, the LCD monitor 86 is manually rotated from the retracted position to a display position, which is partly indicated by a broken line in FIG. 7, by a user. At this time, the screen of the LCD monitor 86 can be observed from the side of the ocular lens systems 18R and 18L.

As is apparent from FIGS. 1, 2, and 3, the left end portion of the movable casing section 10B is partitioned by the partition 29 and a battery chamber 90 is defined. The battery chamber 90 is loaded with two batteries 92 and supplies the electric power to the electric power source circuit board 82 through electric power supply cords (not shown). The electric power is supplied from the electric power source circuit board 82 to the CCD on the CCD-mount electric circuit board 72, the electronic devices (e.g. the microcomputer, memory, and etc.) provided on the main circuit board 84, and the LCD monitor 86.

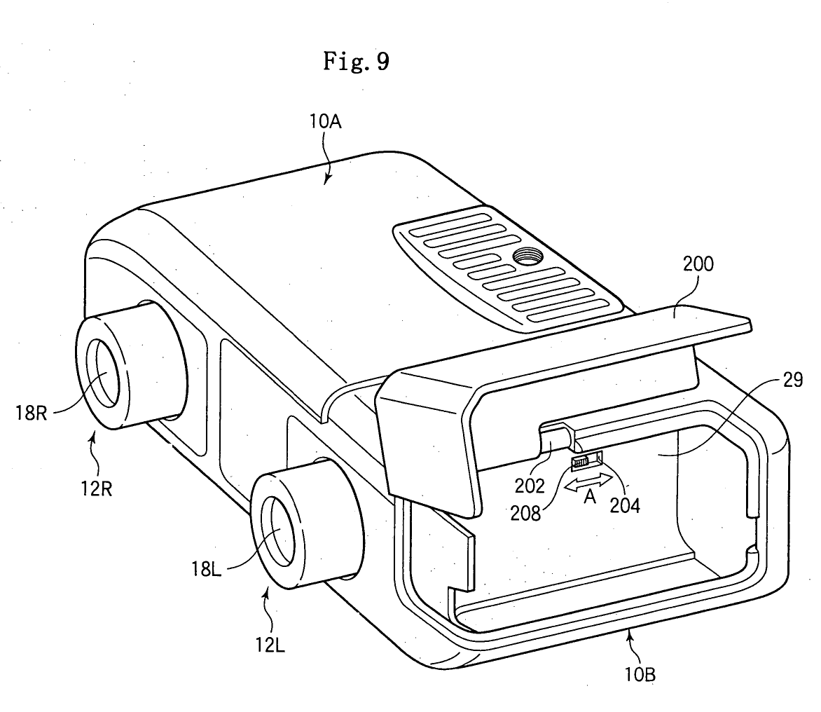

Further, a part of the outer sidewall of the battery chamber 90 is provided as a battery cover 200. The battery cover 200 is connected to the left side end of the base sidewall of the movable casing section 10B via a hinge 202. Namely, the battery cover 200 can be opened or closed by rotating the battery cover 200 about the hinge 202 (refer FIG. 9). On the lower side of the partition 29 and beside the main control circuit board 84, a rectangular opening 204 is formed that connects the battery chamber 90 to the adjacent chamber where the main control circuit board 84 is disposed. As illustrated in FIG. 2, a slide-switch 206 is attached to the main control circuit board 84 in the position which corresponds to the opening 204. Namely, when the movable casing section 10B is positioned at the retracted position, the slider (operating member) 208 of the slide switch 206 mates with the opening 204. Further, when the movable casing section 10B is moved from the retracted position to the maximum-extended position, the opening 204 parts from the slide switch 206. Note that, the slide switch 206 is a video signal standard selector that is used to select one of a group of video signal standards (or TV standards) for video signals which are output from the video output connector 94. The slide switch 206 has three selective positions which correspond the NTSC, PAL, and SECAM standard video signals.

As shown in FIG. 2 and FIG. 3, the electric power source circuit board 82 is provided with connectors, such as the video output connector 94 and a USB connector 95. The video output connector 94 and the USB connector 95 are aligned vertically and are used for connecting an image processing computer (not shown) thereto. The electric power source circuit board 82 is covered by a shield cover 96 together with the connectors 94 and 95. The shield cover is formed of a suitable conductive material, such as a steel sheet with a suitable thickness.

Namely, the electric power source circuit board 82, the connectors 94 and 95, and the shield cover 96 are installed inside the right end portion of the main casing section 10A while two batteries 92 are loaded inside the left end portion of the movable casing section 10B. Needless to say, the weight of the batteries 92 are comparatively heavy when it is compared with the above elements installed inside the right end portion of the main casing section 10A. Thereby, the lateral-weight balance of the digital-camera-provided binoculars is biased to the left side where the batteries 92 are loaded. Therefore, when a user supports the digital-camera-provided binoculars with both hands, the weight supported by the left hand might be heavier than the weight supported by the right hand.

Consequently, in the present embodiment, the thickness of the shield cover 96 is adjusted in accordance with the weight of the batteries 92 in order to maintain the lateral weight balance of the digital-camera-provided binoculars. Namely, the weight of the electric power source circuit board 82, the connectors 94 and 95, and the shield cover 96 is set to counterbalanced the weight of the two batteries 92. If necessary, as illustrated in FIGS. 1, 2, and 3, a counterbalance or a counterweight CW formed of relatively heavy metal, such as a steel plate, a zinc plate, or a lead plate, may be provided on the inner face of the right sidewall of the main casing section 10A, to counterbalance the digital-camera-provided binoculars in the lateral direction. Needless to say, the position where the counterweight CW is attached is not restricted to the right sidewall of the main casing section 10A, it could also be positioned on the shield cover 96.

Further, as illustrated in FIGS. 2 and 3, a CF card holder 97 is provided beneath the main control circuit board 84. A CF card, as a memory card, can be inserted into or pulled out from the CF card holder 97.

A switch group (not shown) for operating the image-pickup operation of the CCD 74, includes a power switch, display switch, release switch, and so on, and is suitably provided on the top surface of the main casing section 10A. When the power switch is turned on and when the display switch is switched on, an image of an object formed on the imaging surface of the CCD 74 is photo-electrically converted into one frame of image signals. The one frame of image signals is readout successibly from the CCD 74 at a predetermined time interval, then subjected to suitable image processes, and converted to digital image data. The one frame of image data is then temporally stored in a frame memory provided on the main control circuit board 84, and is output therefrom as digital video signals. Further, the digital video signals are converted to analog video signals and fed to the LCD monitor 86. Thereby, the movie picture of the object is displayed on the screen of the LCD monitor 86.

When the release switch is depressed, the one frame of imaged data stored in the above frame memory is readout as still image data and transferred to a memory inside the microcomputer provided on the main control circuit board 84. Further, suitable image processes are performed on the still image data and the image data is then stored in the CF card in accordance with a predetermined format. The CF can be taken out from the CF card holder 97 when it is required and may be attached to a CF card driver of the image processing computer, thereby the one frame of image data is output as a photographed image by a printer, for example, after performing suitable image processes. On the other hand, when the digital-camera-provided binoculars are connected to the image processing computer through the connector 94 or 95, image data can be transmitted to the image processing computer without detaching the CF card from the CF card holder 97.

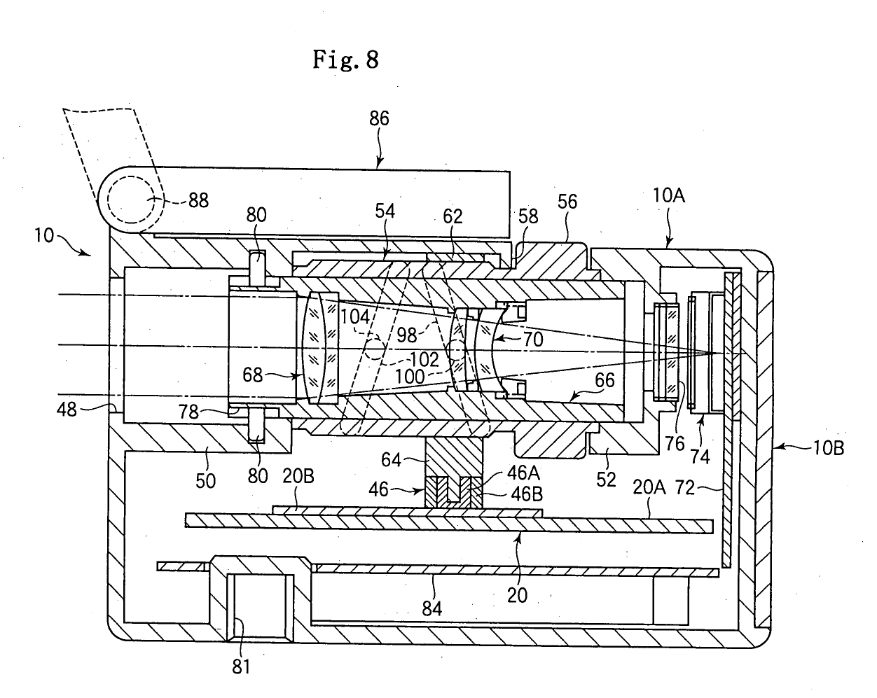

FIG. 8 is a cross sectional elevational view of an alternate embodiment corresponding to FIG. 7 of the above-explained embodiment. In the alternate embodiment illustrated in FIG. 8, the motion conversion mechanism for converting the revolution of the focusing drive barrel 54 to the translation of the annular frame 62 and the motion conversion mechanism for converting the revolution of the focusing drive barrel 54 to the translation of the lens barrel 66 are different from the above-described embodiment. However, other than this point, the digital-camera-provided binoculars of FIG. 8 are substantially same as the binoculars depicted in FIG. 1 through FIG. 7. Note that, in FIG. 8, the same reference numerals are used for the same elements indicated in FIG. 7.

In the alternate embodiment illustrated in FIG. 8, a cam groove 98 (in FIG. 8, the cam groove 98 is illustrated by a phantom line as being developed in the plane) is formed on the outer periphery of the focusing drive barrel 54. A short shaft 100 or a cam follower that protrudes from the inner periphery of the annular frame 62 slidably engages with the cam groove 98. Namely, a motion conversion mechanism for converting rotation of the focusing drive barrel 54 to translation of the annular frame 62 is provided by the engagement of the cam groove 98 and the short shaft 100. On the other hand, the inner periphery of the focusing drive barrel 54 is provided with a cam groove 102 (in FIG. 8, the cam groove 102 is illustrated by a phantom line as being developed in the plane). A short shaft 104 or a cam follower that protrudes from the outer periphery of the lens barrel 66 slidably engages with the cam groove 102. Namely, a motion conversion mechanism for converting rotation of the focusing drive barrel 54 to linear translation of the lens barrel 66 is provided by the engagement of the cam groove 102 and the short shaft 104.

When a motion conversion mechanism is provided by the screw mating between a male and female thread, as described in the embodiment depicted in FIG. 1 through FIG. 7, the relation between the amount of rotation of the focusing drive barrel 54 and the amount of translation of the annular frame 62 or the lens barrel 66 is linear. However, the distance between the objective lens system (14R, 14L) and the erecting prism systems (16R, 16L), and the distance between imaging surface of the CCD 74 and the photographing optical system (68, 70) are not always linear to the distance to the in-focus positions of the telescopic lens systems (12R, 12L) and the photographing optical system (68, 70).

Therefore, to provide a precise focusing mechanism for a pair of the telescopic lens systems (12R, 12L) or the photographing optical systems (68, 70), a motion conversion mechanism may be formed by the cam groove (98, 102) and the short shaft (100, 104) as the present alternate embodiment shown in FIG. 8. This is because the above combinations facilitate the adoption of a motion conversion mechanism which produces a non-linear relation between the revolution of the focusing drive barrel 54 and the linear translation of the annular frame 62 and the lens barrel 66. Thereby, precise focusing can be carried out in the pair of telescopic lens systems (12R, 12L) and the photographing optical system (68, 70). However, the motion conversion mechanism provided by the screw mating of male and female threads, as shown in the embodiment of FIG. 1 to FIG. 7, has no problems in practical use, since the telescopic lens systems (12R, 12L) and the photographing optical system (68, 70) have some degree of focal depth.

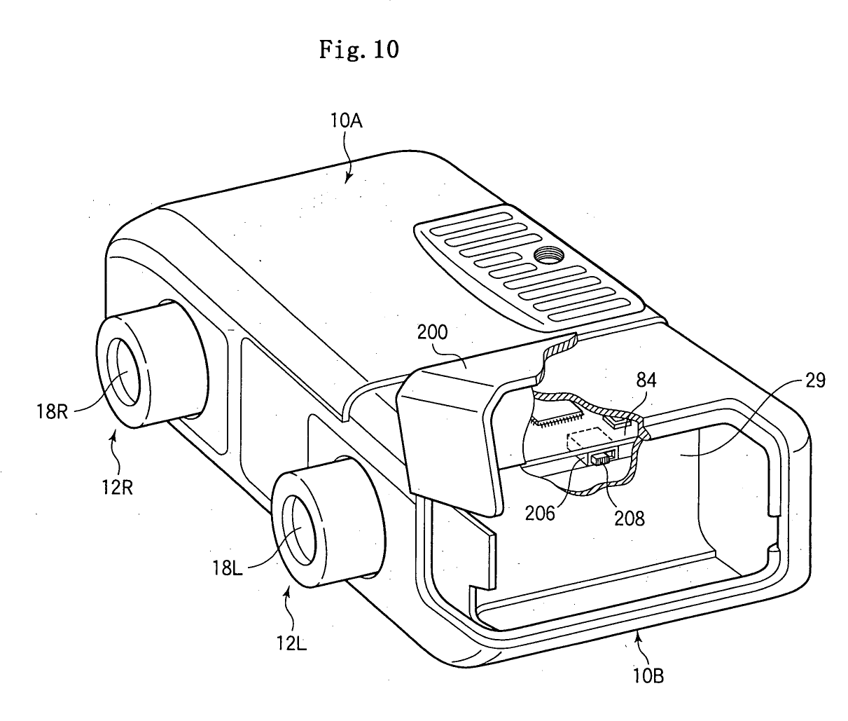

FIGS. 9 and 10 are perspective views from the bottom side of the digital-camera-provided binoculars with the battery cover 200 opened. The figures indicate the arrangement of the slide switch 206 inside the battery chamber 90. Note that, the battery cover 200 and the casing around the slide switch 206 are partly cut away (the partition 29 and the base of the movable casing section 10B) in FIG. 10.

When batteries 92 are installed inside the battery chamber 90, the opening 204 is concealed behind the batteries 92 as shown in FIG. 2. However, when the batteries 92 are removed from the battery chamber 90, the opening 204 is exposed. At this time, the slider 208 of the slide switch 206 is positioned at the opening 204 when the movable casing section 10B is at the retracted position. Thereby, a user can operate the slider 208 by using the tip of a stick, e.g. a pen and the like. The slider 208, for example, can be slid in the directions indicated by the double headed arrow “A”, so that one of the video signal standards (e.g. NTSC, PAL, and SECOM) can be alternatively selected.

As described above, according to the present embodiment, a certain standard for transmitting video signals can be selected by using a mechanical switch in a portable electronic device that includes a plurality of video signal standards, so that it is quite easy for ordinary users to understand the way to select a standard and to carry out the operation. Further, although the selection of the video signal transmission standard should be carried out before supplying the electric power, miss operations of the switch (selector) after supplying the power is prevented, since the switch is veiled with batteries and cannot be accessed when the batteries are loaded inside the battery chamber. Furthermore, the batteries should be once detached from the battery chamber in order to operate the switch, so that the switching operation or video signal standard selection is always carried out before supplying the electric power.

Further, the slide switch for selecting the video signal transmission standard, is disposed inside the battery chamber which is provided with the battery cover, so that the switch is protected from dust.

Note that, although the present embodiment is applied to the video signal standard selection of digital-camera-provided binoculars, the invention can also be applied when a portable electronic device is connected to a SCSI, for example. In this case, a DIP switch, for example, may be provided inside the battery chamber, at a position which is covered by a battery when the battery is installed.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2002-305631 (filed Oct. 21, 2002) which is expressly incorporated herein, by reference, in its entirety.

1. A portable electronic device provided with a function which is required to be preset before supplying an electric power to the device, comprising:
a switch to preset said function;
an operating member that is used to switch said switch; and
a battery chamber for loading at least one battery;
wherein said operating member is arranged inside said battery chamber and said operating member is concealed with said battery when said battery is loaded inside said battery chamber.

2. A device according to claim 1, further comprising a video signal output processor, and wherein said function is a selection of a standard among a plurality of video signal transmission standards which are referred to by said video signal output processor.

3. A device according to claim 2, wherein said device comprises binoculars provided with a digital camera.

4. A device according to claim 1, further comprising a chamber provided with said switch, wherein said chamber is separated from said battery chamber by a partition, and said partition is formed with an opening into which said operating member is fitted.
